(19) United States
(12) Patent Application Publication
(10) Pub. No.: US 2011/0058262 A1
(43) Pub. Date: Mar. 10, 2011

(54) Mini Fixed Focus Lens Module

(75) Inventors: Chun-Hong Chen, Taichung (TW); Jian-Wei Lee, Taichung (TW)

(73) Assignee: ASIA OPTICAL CO., INC., Taichung (TW)

(21) Appl. No.: 12/872,591

(22) Filed: Aug. 31, 2010

(30) Foreign Application Priority Data
Sep. 9, 2009 (TW) 98130377

(51) Int. Cl. G02B 9/34

(52) U.S. Cl. 359/738; 359/773

(57) ABSTRACT

A mini fixed focus lens module is provided. From an object end to an image end thereof, the mini fixed focus lens module sequentially includes a first lens, a second lens, a third lens and a fourth lens. The first lens has a positive diopter, the second lens has a negative diopter, the third lens has a positive diopter, the fourth lens has a negative diopter, a combined diopter of the second and third lenses is positive, and the mini fixed focus lens module satisfies the following formula:

0.2<f₂₃/f<1

, wherein f₂₃ is a combined focal length of the second and third lenses, and f is a system focal length of the mini fixed focus lens module. The invention arranges the first, second, third and fourth lenses to control a ratio of the combined focal length to the system focal length.

### CROSS REFERENCE TO RELATED APPLICATIONS

This application claims priority of Taiwan Patent Application No. 98130377, filed on Sep. 9, 2009, the entirety of which is incorporated by reference herein.

### BACKGROUND OF THE INVENTION

1. Field of the Invention

The present invention relates to an optical device, and in particular relates to a mini fixed focus lens module.

2. Description of the Related Art

Portable electronic devices with video or picture capture functions are thin, small and light. Thus, fixed focus lens units are utilized therein. For continued application of fixed focus lens units in miniaturized portable electronic devices, total track thereof must be low and optical performance thereof must be high.

### BRIEF SUMMARY OF THE INVENTION

A detailed description is given in the following embodiments with reference to the accompanying drawings.

A mini fixed focus lens module is provided. From an object end to an image end thereof, the mini fixed focus lens module sequentially comprises a first lens, a second lens, a third lens and a fourth lens. The first lens has a positive diopter, the second lens has a negative diopter, the third lens has a positive diopter, the fourth lens has a negative diopter, a combined diopter of the second and third lenses is positive, and the mini fixed focus lens module satisfies the following formula:

0.2<f₂₃/f<1

, wherein f₂₃ is a combined focal length of the second and third lenses, and f is a system focal length of the mini fixed focus lens module.

The invention arranges the first, second, third and fourth lenses to control a ratio of the combined focal length to the system focal length to increase viewing angle and to reduce total track length (TTL).

### BRIEF DESCRIPTION OF THE DRAWINGS

The present invention can be more fully understood by reading the subsequent detailed description and examples with references made to the accompanying drawings, wherein:

FIG. 1 shows lens arrangement of a mini fixed focus lens module of a first embodiment of the invention;

FIG. 2A is a ray fan diagram of different wave lengths with different image heights of the first embodiment of the invention;

FIG. 2B is a field curvature diagram of the first embodiment of the invention;

FIG. 2C represents distortion with horizontal magnification corresponding to FIG. 2B;

FIG. 3 shows lens arrangement of a mini fixed focus lens module of a second embodiment of the invention; and

FIG. 4 shows lens arrangement of a mini fixed focus lens module of a third embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

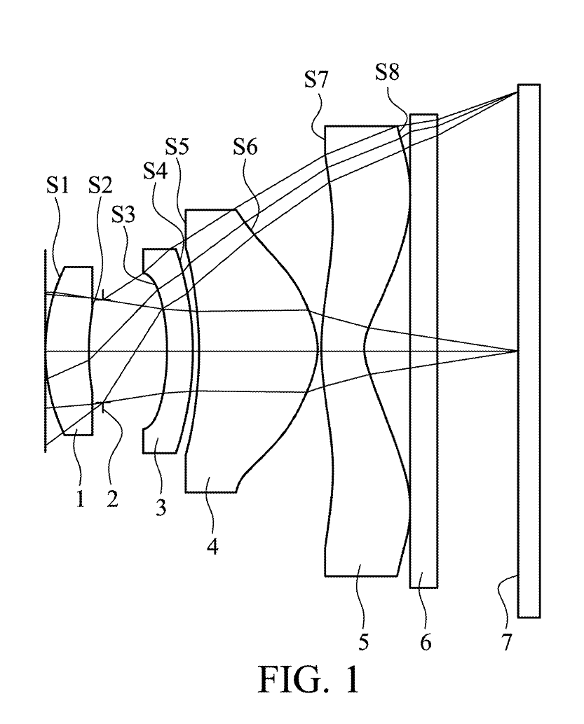

With reference to FIG. 1, a mini fixed focus lens module of an embodiment of the invention is provided. From an object end to an image end thereof, the mini fixed focus lens module sequentially comprises a first lens 1, an aperture stop 2, a second lens 3, a third lens 4 and a fourth lens 5. A light beam passes through the mini fixed focus lens module, enters a cover glass 6, and forms an image on an image sensor (for example, CCD or CMOS) 7. The first lens 1 has a positive diopter. The second lens 3 has a negative diopter. The third lens 4 has a positive diopter. The fourth lens 5 has a negative diopter. The first, second, third and fourth lenses are made of plastic, and are aspheric lenses. The mini fixed focus lens module has a minimum viewing angle equal to 70°.

The first lens 1 is a positive meniscus lens. The first lens 1 provides the majority of the refractive power of the mini fixed focus lens module, and reduces distortion via aspheric design thereof. The aperture stop 2 is a central-arranged diaphragm, located between the first lens 1 and the second lens 3 to increase viewing angle.

The second lens 3 is close to the third lens 4. A combined diopter of the second and third lenses is positive. An object surface S5 of the third lens 4 is concave toward an image surface S6 thereof to reduce a distance between the second and third lenses, and to decrease a total track length (TTL). The mini fixed focus lens module satisfies the following formula:

0.2<f₂₃/f<1 (1)

, wherein f₂₃ is a combined focal length of the second and third lenses, and f is a system focal length of the mini fixed focus lens module. When f₂₃/f>1, the combined diopter of the second and third lenses is too small, and the total track length (TTL) is increased. When f₂₃/f<0.2, radiuses of the second lens 3 and the third lens 4 are too small, and aberration is obvious. The second and third lenses further satisfy the following formula:

2<|f₂|/|f₃|<6 (2)

, wherein f₂ is a focal length of the second lens 3, and f₃ is a focal length of the third lens 4. The second lens 3 and the third lens 4 are compensating lenses of the first lens 1 to increase focusing power and decrease the total track length (TTL). Meanwhile, by satisfying formulas (1) and (2), viewing angle of the mini fixed focus lens module may be increased to more than 70°.

The fourth lens 5 provides a negative diopter refraction to a chief ray, and provides a positive diopter refraction to a marginal ray. The fourth lens 5 balances the positive/negative diopter of the mini fixed focus lens module, and increases viewing angle.

The lenses of the embodiment are plastic aspheric lenses made by injection-molding. Therefore, the lenses can be light in weight and mass produced with low cost. The aspheric surface of the lenses can be represented by the following formula:

$$z = \frac{{ch}^{2}}{1 + {[ 1 - ( k + 1 ) {c}^{2} {h}^{2} ]}^{\frac{1}{2}}} + {Ah}^{4} + {Bh}^{6} + {Ch}^{8} + {Dh}^{10} + {Eh}^{12} + {Fh}^{14} + {Gh}^{16} \qquad ( 3 )$$

With respect to the formula (3), h is the coordinate along the optical axis from an apex of the aspheric surface, z is the vertical distance to the optical axis, k is the conic coefficient, c is the inverse of the radius of curvature, and A to G are aspheric coefficients. Traditional aspheric lenses need more space and long total track length (TTL) to accommodate aberration. An aspheric lens may produce a better image quality than that of a spherical lens.

### First Embodiment

Table 1-1 illustrates the design data of the mini fixed focus lens module of a first embodiment:

TABLE 1-1

| | | | refracting | |
|---|---|---|---|---|
| | curvature radius | thickness | power | Abbe coefficient |
| Ser. No. | (mm) | (mm) | N_{d} | ν_{d} |
| S1 | 0.5039 | 0.1450 | 1.5312 | 56.0438 |
| S2 | 2.3382 | 0.0294 | | |
| aperture | | 0.1969 | | |
| stop | | | | |
| S3 | −0.6880 | 0.0791 | 1.6142 | 25.5765 |
| S4 | −1.9900 | 0.0150 | | |
| S5 | −1.2172 | 0.3679 | 1.5312 | 56.0438 |
| S6 | −0.2196 | 0.0139 | | |
| S7 | 0.7291 | 0.1343 | 1.5441 | 56.0936 |
| S8 | 0.2014 | 0.1390 | | |

S1 is an object surface of the first lens 1, S2 is an image surface of the first lens 1, surfaces S1 to S8 are arranged from the object end to the image end sequentially, and S8 is an image surface of the fourth lens 5. In the first embodiment of the invention, the F-number is 2.8, the system focal length f is 3.5961 mm, the combined focal length f₂₃ of the second and third lenses is 1.701 mm, the focal length f₂ of the second lens is −6.297 mm, and the focal length f₃ of the third lens is 1.608 mm. The focal length f₂ and the focal length f₃ satisfy formula (1) and (2). Additionally, the Abbe coefficient s of the first, third, and fourth lenses are greater than 56 to reduce aberration. The second lens 3 is a negative meniscus lens. The aspheric coefficients of the first, second, third and fourth lens are shown in Table 1-2:

TABLE 1-2

| Serial No. | k | A | B | C | D | E | F | G |
|---|---|---|---|---|---|---|---|---|
| S1 | 1.711365 | −1.54995 | −16.1212 | 31.33032 | −5018.87 | 12253.22 | −11720.3 | −1992657 |
| S2 | −16.2405 | −0.24747 | −17.7322 | 255.1949 | −18579.2 | 204095.5 | 3355235 | −4.8E+07 |
| S3 | 5.874722 | −5.83776 | −27.5103 | −328.854 | 34714.28 | −354303 | −3001148 | 62607739 |
| S4 | 26.17067 | −4.37799 | 6.652809 | 151.4094 | −890.463 | −221.692 | 150321.3 | −783894 |
| S5 | −2.7633 | −0.32154 | 17.61952 | −303.496 | 2629.403 | 1493.215 | −96713.7 | 288244 |
| S6 | −3.56384 | −6.02755 | 31.57182 | −97.9027 | 65.20729 | 994.2698 | 7753.289 | −35705.4 |
| S7 | −5.77958 | −3.65526 | 11.72977 | −16.2513 | 8.069578 | 2.045142 | 2.909506 | −8.24454 |
| S8 | −4.46027 | −2.18997 | 5.599761 | −11.2108 | 9.80279 | 2.872843 | −7.40091 | 0.345971 |

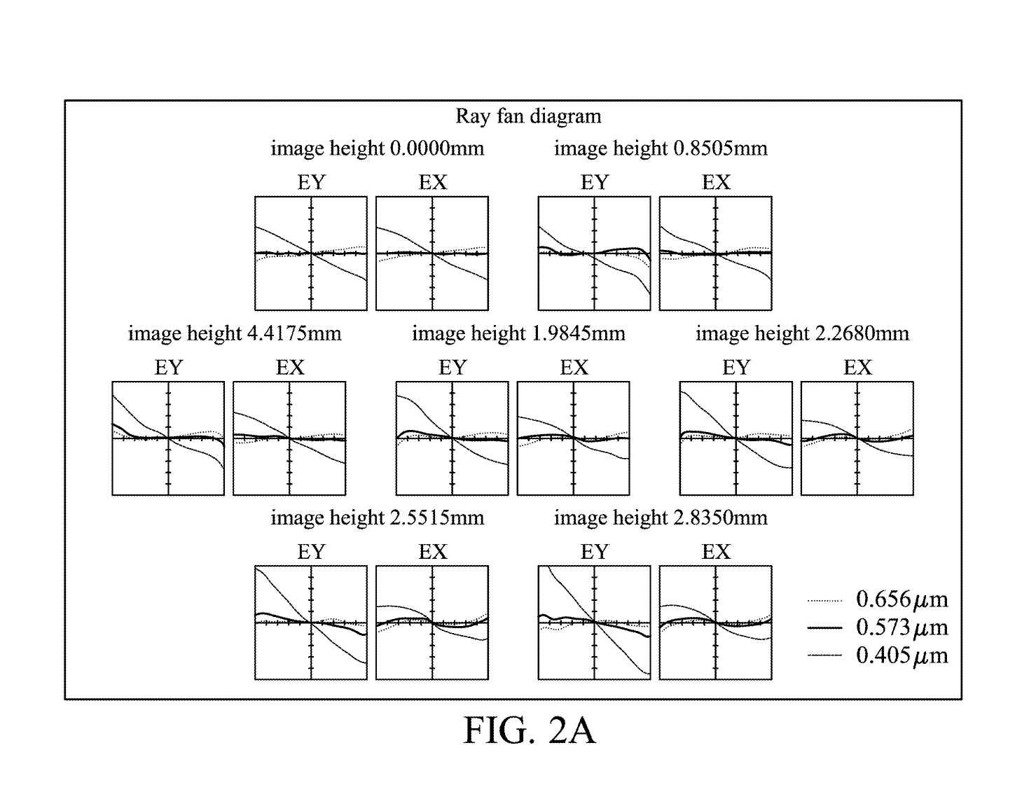

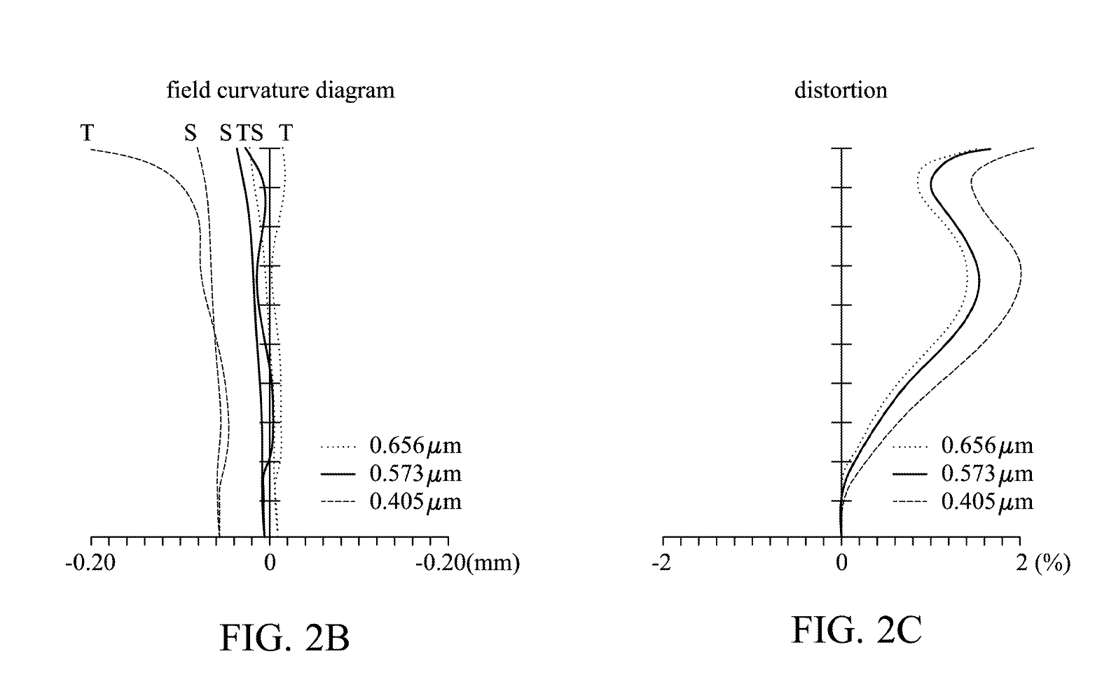

FIG. 2A is a ray fan diagram of different wave lengths with different image height. Each image height has two ray fan diagrams responding to coma aberration on tangential planes (PY and EY) and sagittal planes (PX and EX). According to FIG. 2A, the imaging magnification ratio error is acceptable.

FIG. 2B is a field curvature diagram, showing imaging locations corresponding to different image heights. T and S respectively represent curvature of image fields of the meridional plane and the sagittal plane at different image heights. The horizontal axis represents distance (aberration) from the image point to the ideal image, and the vertical axis represents ideal height of the image. FIG. 2C represents distortion with horizontal magnification corresponding to FIG. 2B, wherein the horizontal axis represents aberration in percentage, and the vertical axis represents the ideal height of the image. As shown in FIGS. 2B and 2C, distortion and image curvature of image field are not serious.

### Second Embodiment

Table 2-1 illustrates the design data of the mini fixed focus lens module of a second embodiment:

TABLE 2-1

| | curvature | | refracting | |
|---|---|---|---|---|
| | radius | thickness | power | Abbe coefficient |
| Ser. No. | (mm) | (mm) | N_{d} | ν_{d} |
| S1 | 0.6159 | 0.1271 | 1.5312 | 56.0438 |
| S2 | 18.4549 | 0.0139 | | |
| aperture stop | | 0.2314 | | |
| S3 | −1.0045 | 0.0911 | 1.6142 | 25.5765 |
| S4 | −6.2687 | 0.0421 | | |
| S5 | −0.8088 | 0.2718 | 1.5312 | 56.0438 |
| S6 | −0.2593 | 0.0139 | | |
| S7 | 0.7315 | 0.1892 | 1.5312 | 56.0438 |
| S8 | 0.2563 | 0.1393 | | |

In the second embodiment, the F-number is 2.8, the system focal length f is 3.588 mm, the combined focal length f₂₃ of the second and third lenses is 2.569 mm, the focal length f₂ of the second lens is −7.035 mm, and the focal length f₃ of the third lens is 2.2015 mm. The focal length f₂ and the focal length f₃ satisfy formula (1) and (2).

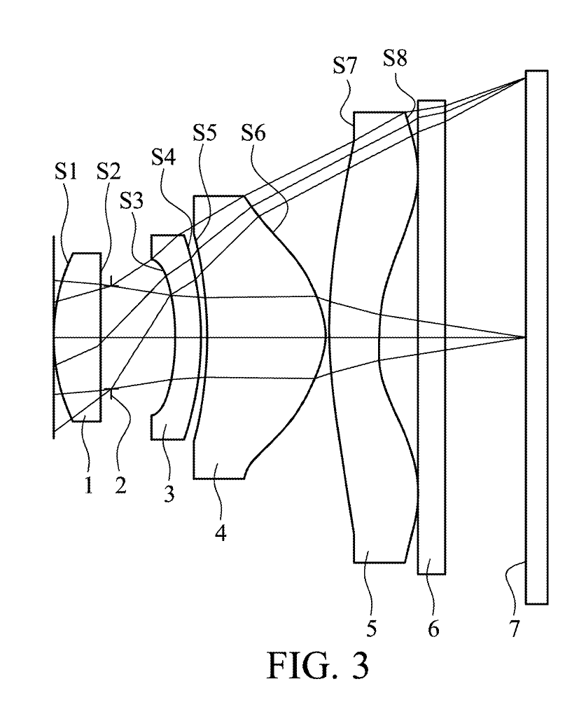

The aspheric coefficients of the first, second, third and fourth lens are shown in Table 2-2. As shown in FIG. 3, lens arrangement and lens shape of the mini fixed focus lens module of the second embodiment can be achieved by referring to Table 2-1 and Table 2-2.

TABLE 2-2

| Ser. No. | k | A | B | C | D | E | F | G |
|---|---|---|---|---|---|---|---|---|
| S1 | −5.65802 | 1.97776 | −18.5922 | −204.469 | 136.7658 | −8861.3 | −72271.8 | −541770 |
| S2 | 329.0738 | −1.38662 | −44.2142 | 672.0624 | −10752.8 | 13497.69 | 4751.156 | 100923.6 |
| S3 | −7.16817 | −7.7289 | −38.3609 | 744.1328 | −932.655 | −12821.8 | −342740 | 3073944 |
| S4 | −81.3991 | −2.73534 | −20.3732 | 255.6185 | −851.731 | −124.91 | 38022.81 | −172036 |
| S5 | −17.4355 | −0.3664 | 0.654212 | −124.752 | 666.641 | 3264.517 | 2178.888 | −139172 |
| S6 | −3.05581 | −4.71099 | 21.68413 | −48.4205 | 103.1734 | 1317.1 | 3612.644 | −34463.6 |
| S7 | −3.29441 | −3.20689 | 10.66603 | −15.9955 | 10.49552 | −1.11244 | 0.697235 | −3.5186 |
| S8 | −4.66174 | −1.71743 | 4.291583 | −9.16498 | 9.691347 | 1.079264 | −8.8016 | 2.694083 |

### Third Embodiment

Table 3-1 illustrates the design data of the mini fixed focus lens module of a third embodiment:

TABLE 3-1

| | | | refracting | |
|---|---|---|---|---|
| | curvature radius | thickness | power | Abbe coefficient |
| Ser. No. | (mm) | (mm) | N_{d} | ν_{d} |
| S1 | 0.6463 | 0.1261 | 1.5312 | 56.0438 |
| S2 | 15.4876 | 0.0181 | | |
| S3 | −3.3367 | 0.0791 | 1.6142 | 25.5765 |
| S4 | 3.0495 | 0.0764 | | |
| S5 | −0.8738 | 0.3221 | 1.5312 | 56.0438 |
| S6 | −0.248 | 0.0139 | | |
| S7 | 0.508 | 0.1421 | 1.5855 | 29.9092 |
| S8 | 0.2057 | 0.2784 | | |

In the third embodiment, the F-number is 2.8, the system focal length f is 3.592 mm, the combined focal length f₂₃ of the second and third lenses is 2.157 mm, the focal length f₂ of the second lens is −9.275 mm, and the focal length f₃ of the third lens is 1.987 mm. The focal length f₂ and the focal length f₃ satisfy formula (1) and (2). The second lens 3 is a biconcave lens.

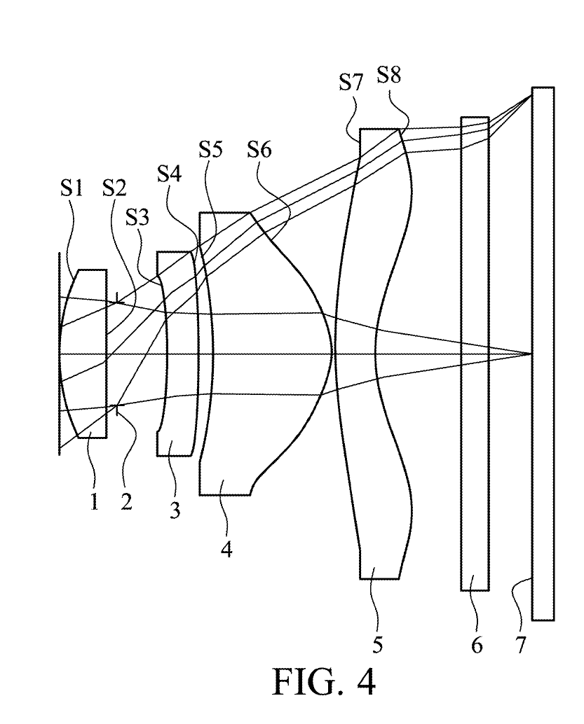

The aspheric coefficients of the first, second, third and fourth lens are shown in Table 3-2. As shown in FIG. 4, lens arrangement and lens shape of the mini fixed focus lens module of the second embodiment can be achieved by referring to Table 3-1 and Table 3-2.

TABLE 3-2

| Serial No. | k | A | B | C | D | E | F | G |
|---|---|---|---|---|---|---|---|---|
| S1 | −6.23379 | 1.839228 | −16.588 | −241.848 | 642.9472 | 14433.07 | −415932 | 837637.6 |
| S2 | 0 | −1.3206 | −44.0317 | 770.2913 | −12677.9 | 37322.72 | 6516.022 | 157340 |
| S3 | 94.27759 | −4.56351 | −54.3325 | 843.0139 | −2021.37 | −8872.37 | −228426 | 1383509 |
| S4 | −284.866 | −0.90906 | −38.4953 | 364.0487 | −721.944 | −2266.04 | −2542.95 | 38517.98 |
| S5 | −19.2101 | −0.91086 | 6.507327 | −131.909 | 163.7292 | 2520.77 | 10155.23 | −87427.9 |
| S6 | −3.54404 | −4.70474 | 19.45443 | −39.2818 | 10.57235 | 326.0565 | 1019.118 | −1790.81 |
| S7 | −4.79393 | −2.74903 | 10.28662 | −17.4072 | 12.73998 | −0.32582 | −0.84166 | −3.42917 |
| S8 | −3.9064 | −1.72367 | 4.259129 | −6.12457 | 3.421952 | 1.451318 | −0.49915 | −2.22007 |

As mentioned above, in the embodiment, the ratio of the combined focal length to the system focal length satisfies formula (1), and the focal length ratio of the second to third lenses satisfies formula (2). The second lens 3 is disposed close to the third lens 4. The aperture stop 2 is disposed between the first lens 1 and the second lens 3 to increase the viewing angle of the mini fixed focus lens module, and to reduce total track. Additionally, the first, second, third and fourth lenses are aspheric plastic lenses, which can reduce aberration, weight and cost.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mini fixed focus lens module, from an object end to an image end sequentially comprising:
a first lens, a second lens, a third lens and a fourth lens, wherein the first lens has a positive diopter, the second lens has a negative diopter, the third lens has a positive diopter, the fourth lens has a negative diopter, a combined diopter of the second and third lenses is positive, and the mini fixed focus lens module satisfies the following formula:
0.2<f₂₃/f<1
, wherein f₂₃ is a combined focal length of the second and third lenses, and f is a system focal length of the mini fixed focus lens module.

2. The mini fixed focus lens module as claimed in claim 1, wherein an object surface of the third lens is concave toward an image surface thereof.

3. The mini fixed focus lens module as claimed in claim 2, wherein the mini fixed focus lens module satisfies the following formula:
2<|f₂|/|f₃|<6
, wherein f₂ is a focal length of the second lens, and f₃ is a focal length of the third lens.

4. The mini fixed focus lens module as claimed in claim 3, further comprising an aperture stop located between the first and second lenses.

5. The mini fixed focus lens module as claimed in claim 4, wherein the first lens, the second lens, the third lens, the fourth lens and the aperture stop are arranged with a minimum viewing angle substantially equal to 70°.
